(19) United States
(12) Patent Application Publication
(10) Pub. No.: US 2025/0303757 A1
(43) Pub. Date: Oct. 2, 2025

(54) RECORDING APPARATUS, CONTROL METHOD OF RECORDING APPARATUS, AND NON-TRANSITORY COMPUTER-READABLE STORAGE MEDIUM STORING CONTROL PROGRAM OF RECORDING APPARATUS

(71) Applicant: BROTHER KOGYO KABUSHIKI KAISHA, Nagoya (JP)

(72) Inventors: Yusuke ARAI, Nagoya (JP); Isao KOBAYASHI, Nagoya (JP); Hiroaki TAKAHASHI, Nagoya (JP)

(73) Assignee: BROTHER KOGYO KABUSHIKI KAISHA, Nagoya (JP)

(21) Appl. No.: 19/083,198

(22) Filed: Mar. 18, 2025

(30) Foreign Application Priority Data
Mar. 28, 2024 (JP) 2024-054948

(51) Int. Cl. B41J 13/00; B41J 11/00; B41J 11/66; B41J 11/70; B41J 13/03

(52) U.S. Cl. CPC B41J 13/0018; B41J 11/008; B41J 11/663; B41J 11/70; B41J 13/0027; B41J 13/03

(57) ABSTRACT

A recording apparatus includes an accommodating part which accommodates a medium, a recording part, a cutting part, a conveyor, and a controller. A cutting position of the medium is located upstream of the recording part in the first conveyance path. The controller executes first control so as to generate a first recorded item in which a first image is recorded on a first medium and a second recorded item in which a second image is recorded on a second medium.

### REFERENCE TO RELATED APPLICATIONS

This application claims priority from Japanese Patent Application No. 2024-054948 filed on Mar. 28, 2024. The entire content of the priority application is incorporated herein by reference.

### BACKGROUND ART

A certain known image forming apparatus (recording apparatus) includes a sheet feeding part which feeds a sheet, and a cutter (cutting part) is disposed downstream of a sheet feeding cassette of the sheet feeding part in a conveyance path. The sheet taken out of the sheet feeding cassette is cut and divided by the cutter. A recording part of the image forming apparatus records an image on the divided sheet(s).

### SUMMARY

In the above-described image forming apparatus, a space corresponding to the distance from the recording part to the cutter (cutting part) needs to be defined inside the image forming apparatus, which in turn causes the image forming apparatus to become large-sized.

An object of the present disclosure is to provide a technique for reducing the increase in the size of an apparatus having the configuration with the recording part and the cutting part.

A recording apparatus according to an aspect of the present disclosure includes: an accommodating part configured to accommodate a medium; a recording part configured to record an image on the medium; a conveyor configured to convey the medium from the accommodating part toward the recording part along a first conveyance path; a cutting part configured to cut the medium at a cutting position and divide the medium into a first medium and a second medium; and a controller. The cutting position is located upstream of the recording part in the first conveyance path. The controller is configured to execute first control to generate a first recorded item in which a first image is recorded on the first medium and a second recorded item in which a second image is recorded on the second medium. The first control includes: causing the conveyor to convey one medium accommodated in the accommodating part so that a cutting planned position of the one medium is located at the cutting position; causing the cutting part to cut the conveyed one medium and divide the one medium into the first medium and the second medium; causing the conveyor to convey the first medium from downstream toward upstream of the first conveyance path so as to locate the first medium at a recording start position; causing the recording part to record the first image on the first medium; and after causing the recording part to record the first image on the first medium, causing the recording part to record the second image on the second medium.

According to the present disclosure, the cutting position is located upstream of the recording part in the first conveyance path. In this configuration, in the first control, the controller causes the cutting part to cut the conveyed one medium and to divide the one medium into the first medium and the second medium; then the controller causes the conveyor to perform the conveyance including conveyance in the opposite direction (conveying the first medium and the second medium from downstream toward upstream of the first conveyance path); and then the controller causes the recording part to perform the recording. This reduces the distance from the recording part to the cutting position and reduces the increase in the size of the recording apparatus.

### BRIEF DESCRIPTION OF DRAWINGS

FIG. 1 is a perspective view of a printer 1.

FIG. 2 is a vertical cross-sectional view depicting the internal structure of the printer 1 of FIG. 1.

FIG. 3 is a block diagram depicting the electrical configuration of the printer 1 of FIG. 1.

FIG. 4 is a flow chart indicating a program executed by a CPU of the printer 1 of FIG. 1.

FIG. 5A is a schematic view depicting step S31 of FIG. 4.

FIG. 5B is a schematic view depicting step S32 of FIG. 4.

FIG. 5C is a schematic view depicting step S33 of FIG. 4.

FIG. 5D is a schematic view depicting step S34 of FIG. 4.

FIG. 6A is a schematic view depicting step S41 of FIG. 4.

FIG. 6B is a schematic view depicting step S42 of FIG. 4.

FIG. 6C is a schematic view depicting step S43 of FIG. 4.

FIG. 6D is a schematic view depicting step S44 of FIG. 4.

FIG. 6E is a schematic view depicting step S45 of FIG. 4.

FIG. 7 is a vertical cross-sectional view depicting the internal structure of a printer 2.

FIG. 8A is a schematic view depicting step S31 of FIG. 4.

FIG. 8B is a schematic view depicting step S32 of FIG. 4.

FIG. 8C is a schematic view depicting a state that second conveyance is started in step S33 of FIG. 4.

FIG. 8D is a schematic view depicting a state that the second conveyance is completed in step S33 of FIG. 4.

FIG. 8E is a schematic view depicting step S34 of FIG. 4.

FIG. 9A is a schematic view depicting step S31 of FIG. 4.

FIG. 9B is a schematic view depicting step S32 of FIG. 4.

FIG. 9C is a schematic view depicting a state that the second conveyance is started with respect to a first half part in step S33 of FIG. 4.

FIG. 9D is a schematic view depicting a state that the second conveyance is completed with respect to the first half part in step S33 of FIG. 4.

FIG. 9E is a schematic view depicting step S34 of FIG. 4.

FIG. 10 is a vertical cross-sectional view depicting the internal structure of a printer.

FIG. 11 is a flow chart depicting a program executed by a CPU of the printer.

### DESCRIPTION

### First Embodiment

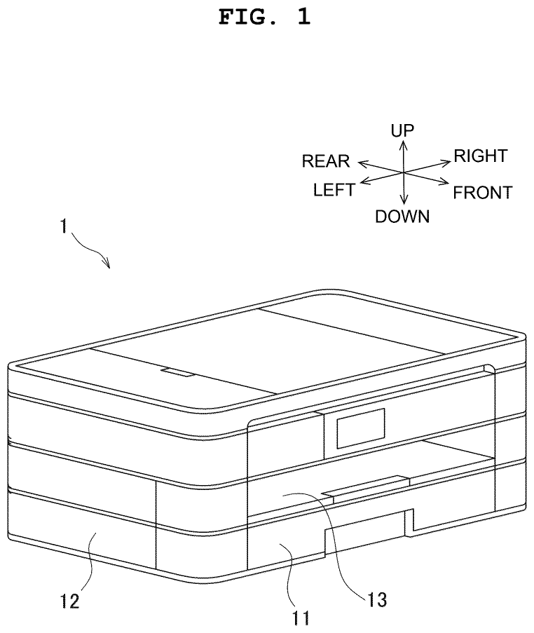

A printer 1 depicted in FIG. 1 is a first embodiment of a “recording apparatus” according to the present disclosure. In the following description, the respective directions of the printer 1 which are the up-down direction, left-right direction and front-rear direction are defined based on a state of FIG. 1 in which the printer 1 is disposed to be usable.

As depicted in FIG. 1, the printer 1 has a casing 12 having a shape of a substantially rectangular parallelepiped, a sheet feed tray 11 disposed in a lower part of the casing 12, and a sheet discharge tray 13 disposed above the sheet feed tray 11 in the inside of the casing 12.

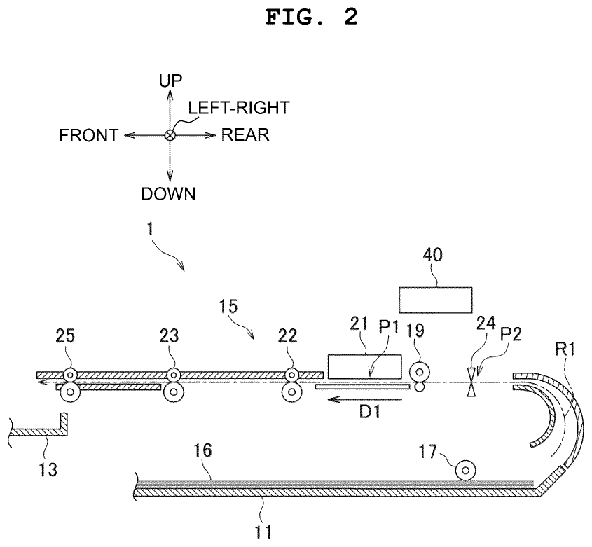

The sheet feed tray 11 is detachable and attachable with respect to the casing 12. As depicted in FIG. 2, the sheet feed tray 11 can accommodate a plurality of sheets 16, and sheets 16 of a plurality of sizes. The plurality of sizes includes A4 size and A5 size, and in a case where each of the sheets 16 having one of the sizes is placed in the sheet feed tray 11, a length in the front-rear direction is different amount the sheets 16 of the plurality of sizes. The sheet 16 corresponds to a “medium” of the present disclosure. The sheet feed tray 11 corresponds to an “accommodating part” of the present disclosure.

The printer 1 has a recording part 21, a cutting part 24, a conveyor 15, and a control unit 40 inside the casing 12.

The recording part 21 is of an ink-jet system, and includes an ink channel having a plurality of nozzles, and a driver IC. The plurality of nozzles are open in the lower surface of the recording part 21. In a case where the driver IC is driven under the control of the control unit 40, pressure is applied to the ink channel, and an ink is ejected from each of the nozzles. As a result, ink droplets of the ink land on the sheet 16 located at a recording position P1, and an image is recorded on the sheet 16. The recording position PI is defined below the recording part 21. The recording part 21 may be either of a line system or a serial system.

The cutting part 24 has a cutting blade and a cutting motor. The cutting blade includes a fixed blade and a rotary blade. In a case where the cutting motor is driven under the control of the control unit 40, the rotary blade moves in the left-right direction while rotating. As a result, the sheet 16 is cut at a cutting position P2 and is divided into a first half part and a second half part. The cutting position P2 is a position at which the rotary blade moves in the left-right direction while contacting the fixed blade.

The conveyor 15 conveys the sheet 16 from the sheet feed tray 11 toward the recording part 21 along a conveyance path R1. The conveyance path RI corresponds to a “first conveyance path” of the present disclosure, and spans from the sheet feed tray 11 and reaches the sheet discharge tray 13 passing through the cutting position P2 and the recording position P1. In a case where the sheet 16 passes through the recording position P1, the sheet 16 is conveyed in a first direction D1 (frontward).

The cutting position P2 is located upstream of the recording part 21 in the conveyance path R1. A distance from the recording part 21 to the cutting position P2 in the conveyance path R1 is smaller than half a length along the first conveyance path R1 of a sheet 16 of which length along the first conveyance path R1 is the greatest among the sheets 16 of the plurality of sizes which can be accommodated in the sheet feed tray 11. For example, the distance is 182 mm or less.

The conveyor 15 includes a sheet feeding roller 17, conveying roller pairs 19, 22, 23 and 25, and a conveying motor. The sheet feeding roller 17 and the conveying roller pairs 19, 22, 23 and 25 are rotated by the driving of the conveying motor.

The sheet feeding roller 17 is positioned so as to contact the front surface of an uppermost sheet 16 among the plurality of sheets 16 accommodated in the sheet feed tray 11.

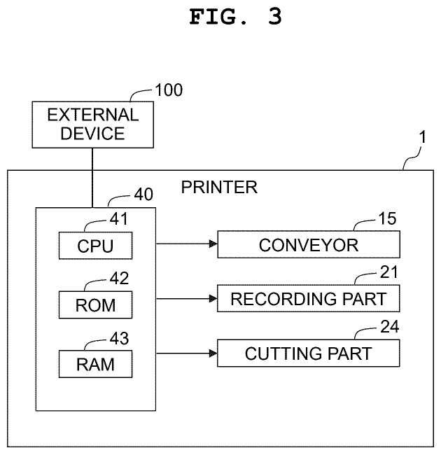

As depicted in FIG. 3, the control unit 40 includes a CPU 41, a ROM 42 and a RAM 43. The CPU 41 corresponds to a “controller” of the present disclosure. The ROM 42 stores a program and/or data with which the CPU 41 performs various kinds of control. The RAM 43 temporarily stores data to be used in a case where the CPU 41 executes the program.

The control unit 40 is electrically connected to the conveyor 15, the recording part 21 and the cutting part 24. The control unit 40 is also electrically connected to an external device (personal computer, etc.) 100.

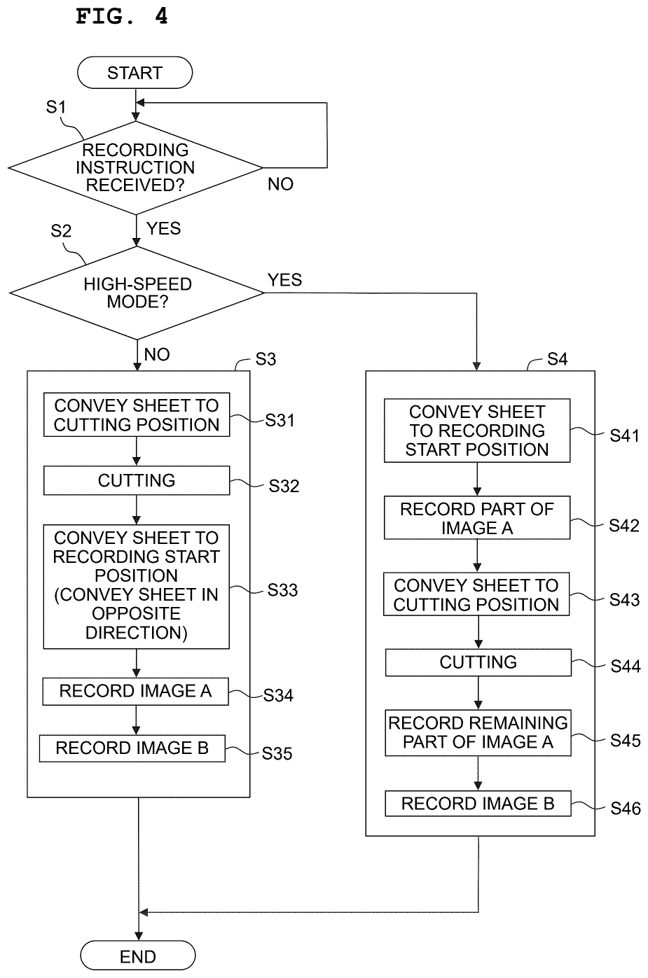

Next, the program executed by the CPU 41 will be described, with reference to FIG. 4.

The CPU 41 first determines whether a recording instruction has been received from the external device 100 (step S1). In a case where the CPU 41 determines that the recording instruction has not been received from the external device 100 (step S1: NO), the CPU 41 repeats the process of step S1.

In a case where the CPU 41 determines that the recording instruction has been received from the external device 100 (step S1: YES), the CPU 41 determines whether the recording mode indicated by the recording instruction is a high-speed mode (step S2). The recording mode includes the high-speed mode and a normal mode of which recording speed is lower than the recording speed of the high-speed mode. The high-speed mode corresponds to a “first mode” of the present disclosure, and the normal mode corresponds to a “second mode” of the present disclosure.

In a case where the CPU 41 determines that the recording mode indicated by the recording instruction is not the high-speed mode (that is, the normal mode) (step S2: NO), the CPU 41 executes the control of step S3 and then ends the program.

In a case where the CPU 41 determines that the recording mode indicated by the recording instruction is the high-speed mode (step S2: YES), the CPU 41 executes the control of step S4 and then ends the program.

Next, the control of each of steps S3 and S4 will be described.

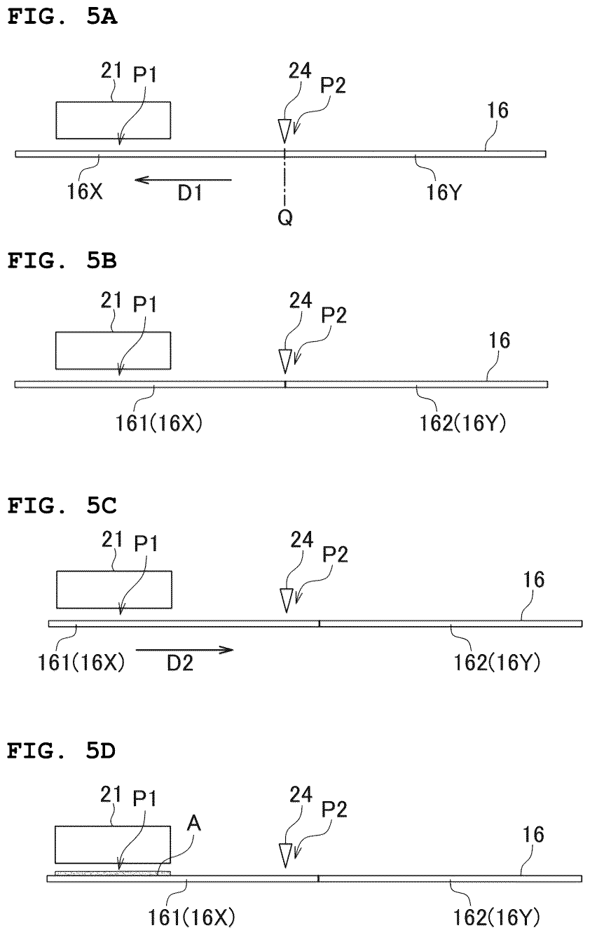

The control of step S3 is a control for generating a first sheet piece 161 in which an image A is recorded on a first half part 16X of a sheet 16, and a second sheet piece 162 in which an image B (not depicted) is recorded on a second half part 16Y of the sheet 16, as depicted in FIGS. 5A to 5D. The control of step S3 corresponds to “first control” of the present disclosure. The first half part 16X is a part located downstream in the first direction DI in the sheet 16. The second half part 16Y is a part located upstream in the first direction DI in the sheet 16. The first half part 16X corresponds to a “first medium” of the present disclosure, and the second half part 16Y corresponds to a “second medium” of the present disclosure. The first sheet piece 161 corresponds to a “first recorded item” of the present disclosure, and the second sheet piece 162 corresponds to a “second recorded item” of the present disclosure. The image A corresponds to a “first image” of the present disclosure, and the image B corresponds to a “second image” of the present disclosure.

In the process of step S3, the CPU 41 first causes the conveyor 15 to convey one sheet 16, among the plurality of sheets 16 accommodated in the sheet feed tray 11, in the first direction DI so that a cutting planned position Q of the one sheet 16 is located at the cutting position P2 (step S31: first conveying process), as depicted in FIG. 5A. The cutting planned position Q is a position along a width direction (left-right direction) of the one sheet 16 which passes through the center of the first direction D1 of the one sheet 16.

After the process of step S31, the CPU 41 causes the cutting part 24 to cut the one sheet 16 (step S32: first cutting process), as depicted in FIG. 5B. With this, the first half part 16X and the second half part 16Y are separated from each other. In this situation, the first half part 16X is located downstream of the second half part 16Y in the conveyance path R1.

After the process of step S32, as depicted in FIG. 5C, the CPU 41 causes the conveyor 15 to perform conveyance of the first half part 16X and the second half part 16Y along the conveyance path R1 (see FIG. 2) in a second direction D2 (conveyance in an opposite direction) (see FIG. 5C), thereby conveying the first half part 16X to the recording start position (step S33: second conveying process). The second direction D2 is the direction opposite to the first direction D1, and is a direction from downstream toward upstream of the conveyance path R1 (rearward).

After the process of step S33, the CPU 41 causes the recording part 21 to record the image A on the first half part 16X, as depicted in FIG. 5D (step S34: first recording process).

After the process of step S34, the CPU 41 causes the conveyor 15 to convey the second half part 16Y to the recording start position, and causes the recording part 21 to record the image B on the second half part 16Y (step S35: second recording process).

By the processes of steps S31 to S35, the first sheet piece 161 in which image A is recorded on the first half part 16X, and the second sheet piece 162 in which image B is recorded on the second half part 16Y are generated.

After the process of step S35, the first sheet piece 161 and the second sheet piece 162 are conveyed in the first direction D1 by the conveyor 15 and are received by the sheet discharge tray 13 (see FIG. 2).

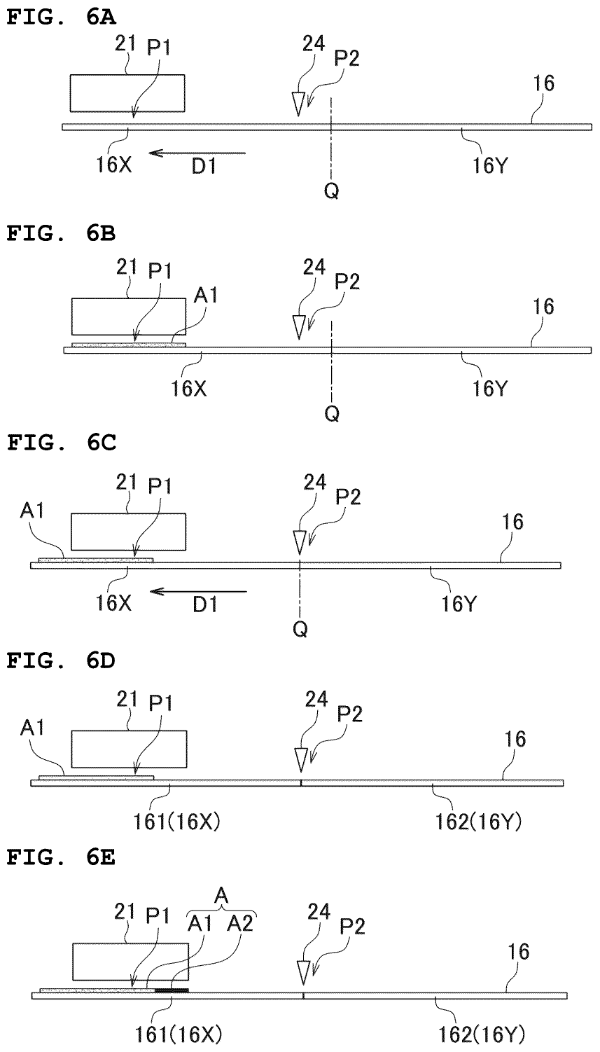

As depicted in FIGS. 6A to 6E, the control of step S4 is a control for generating a first sheet piece 161 in which an image A is recorded on first half part 16X of sheet 16, and a second sheet piece 162 in which an image B (not depicted) is recorded on second half part 16Y of the sheet 16 which are similar to the sheet pieces 161 and 162 generated in step S3. The control of step S4 is a control different from the control (first control) of step S3, and corresponds to “second control” of the present disclosure.

In the process of step S4, the CPU 41 first causes the conveyor 15 to convey one sheet 16 among the plurality of sheets 16 accommodated in the sheet feed tray 11 to the recording start position (step S41: third conveying process), as depicted in FIG. 6A. In this situation, the first half part 16X is located at the recording position P1.

After the process of step S41, the CPU 41 causes the recording part 21 to record a partial image A1, which is a part of the image A, on the first half part 16X, as depicted in FIG. 6B (step S42: second recording process).

After the process of step S42, the CPU 41 causes the conveyor 15 to convey the one sheet 16 by the conveyor 15 in the first direction DI so that the cutting planned position Q of the one sheet 16 is located at the cutting position P2, as depicted in FIG. 6C (step S43: fourth conveying process).

After the process of step S43, the CPU 41 causes the cutting part 24 to cut the one sheet 16 (step S44: second cutting process), as depicted in FIG. 6D. With this, the first half part 16X and the second half part 16Y are separated from each other.

After the process of step S44, the CPU 41 causes the recording part 21 to record a partial image A2, which is the remaining part of the image A, on the first half part 16X, as depicted in FIG. 6E (step S45). In this situation, among the plurality of nozzles of the recording part 21, only the nozzles on the upstream side of the first direction D1 are used.

After the process of step S45, the CPU 41 causes the recording part 21 to record the image B on the second half part 16Y (step S46: third recording process).

By the processes of steps S41 to S46, the first sheet piece 161 in which image A is recorded on the first half part 16X, and the second sheet piece 162 in which image B is recorded on the second half part 16Y are generated.

After the process of step S46, the first sheet piece 161 and the second sheet piece 162 are conveyed in the first direction DI by the conveyor 15 and are received by the sheet discharge tray 13 (see FIG. 2).

As described above, according to the present embodiment, the cutting position P2 is located upstream of the recording part 21 in the conveyance path R1 (see FIG. 2). In this configuration, the CPU 41 is capable of executing the first control (step S3) to generate the first sheet piece 161 in which the image A is recorded on the first half part 16X and the second sheet piece 162 in which the image B is recorded on the second half part 16Y. In the first control (step S3), after the cutting process (step S32: see FIG. 5B), the second conveying process (step S33: see FIG. 5C) including the conveyance (of the sheet 16) in the opposite direction is executed, and then the recording process (steps S34, S35: see FIG. 5D) is executed. With this, the distance from the recording part 21 to the cutting position P2 can be shortened and the increase in size of the printer 1 can be reduced.

In a case where the CPU 41 determines that the high-speed mode has been selected (step S2: YES), the CPU 41 is capable of executing the second control (step S4), which is different from first control (step S3), in order to generate the first sheet piece 161 in which image A is recorded on the first half part 16X and the second sheet piece 162 in which the image B is recorded on the second half part 16Y. In a case where a user wishes to prioritize the recording speed, the high-speed mode is selected. In this case, by executing the second control (step S4) instead of the first control (step S3), the recording speed can be increased and the recording desired by the user can be realized.

In the second conveying process (step S33: see FIG. 5C), the CPU 41 causes the conveyor 15 to convey the second half part 16Y together with the first half part 16X. In a case where the first half part 16X and the second half part 16Y are handled separately in the second conveying process (for example, in a case where the first half part 16X is conveyed in a state that the second half part 16Y is held at a predetermined position), the driving of the conveying motor needs to be switched and/or the usage of gears is required, which might complicate the configuration and/or the control of the conveyor. In view of this situation, in the configuration of the present embodiment, the second half part 16Y is conveyed together with the first half part 16X, and thus the driving of the conveying motor needs not to be switched and/or the usage of gears is not required, simplifying the configuration and/or the control of the conveyor.

The distance from the recording part 21 to the cutting position P2 in the conveyance path R1 is smaller than half the length along the first conveyance path R1 of the sheet 16 of which length along the first conveyance path RI is the greatest among the sheets 16 of the plurality of sizes which can be accommodated in the sheet feed tray 11. In this case, the printer 1 can be made small-sized.

The distance from the recording part 21 to the cutting position P2 in the conveyance path R1 is 182 mm or less. In this case, the printer I can be made small-sized in an ensured manner.

### Second Embodiment

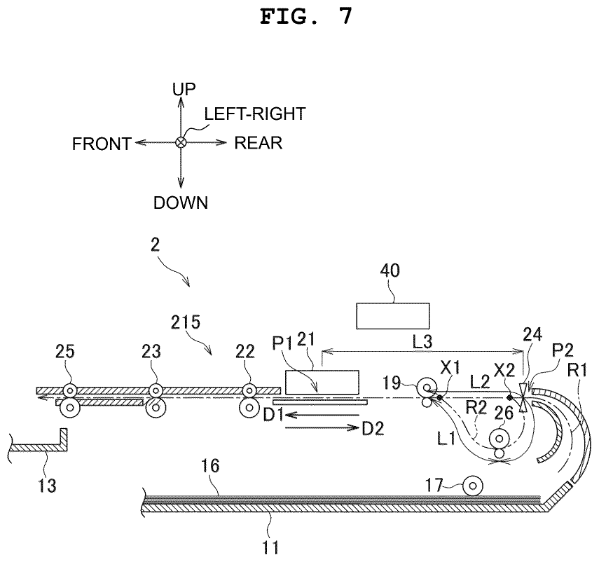

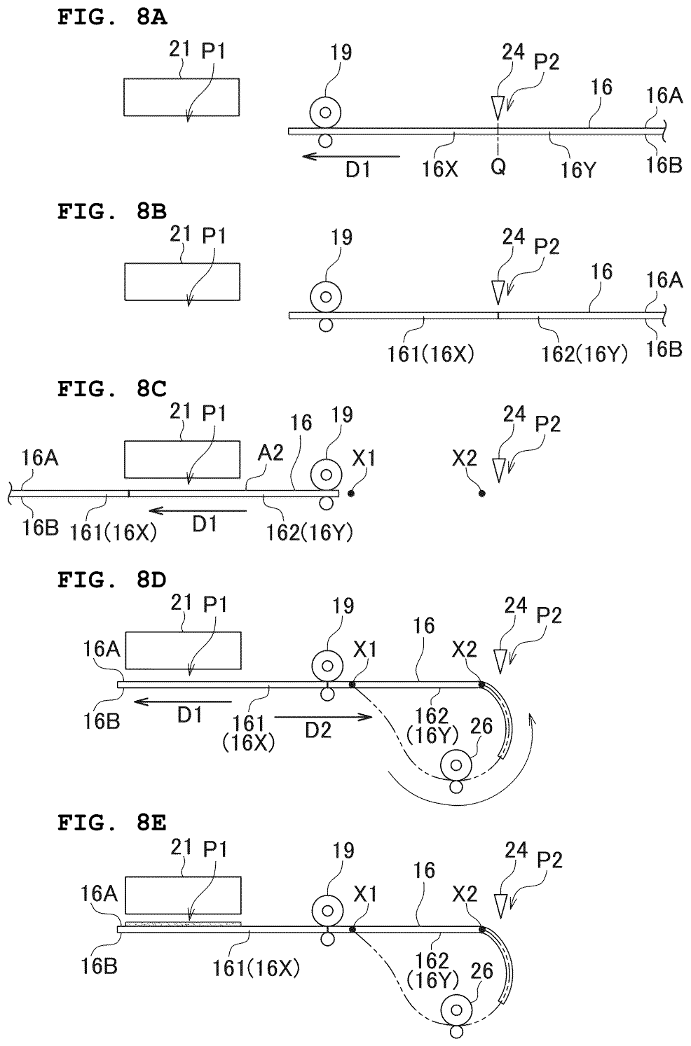

Next, a second embodiment of the present disclosure will be described with reference to FIG. 7 and FIG. 8A to FIG. 8E.

A printer 2 depicted in FIG. 7 is the second embodiment of the “recording apparatus” according to the present disclosure. The printer 2 has a configuration similar to the configuration of the printer 1 (see FIG. 2) of the first embodiment, except for the configuration of a conveyor 215.

In the second conveying process (step S33) of the first embodiment, the CPU 41 causes the conveyor 15 to convey the first half part 16X and the second half part 16Y along conveyance path R1 (see FIG. 2). In contrast, in the second conveying process (step S33) of the second embodiment, the CPU 41 causes the conveyor 215 to convey the first half part 16X and the second half part 16Y along a conveyance path R1 and a conveyance path R2 (see FIG. 7).

The conveyor 215 is capable of first conveyance and second conveyance.

The first conveyance refers to conveying the sheet 16 along the conveyance path R1 so that the front surface of the sheet 16 faces upward (faces the recording part 21) at the recording position P1.

The second conveyance refers to conveying the sheet 16 from the conveyance path R1 and conveying the sheet 16 to return to the conveyance path R1, via the conveyance path R2, so that the sheet 16 is changed from a state that the front surface of sheet 16 faces upward at the recording position P1 to a state that the back surface of the sheet 16 faces upward at the recording position P1.

The front surface of sheet 16 corresponds to a “first surface” of the present disclosure, and the back surface of sheet 16 corresponds to a “second surface” of the present disclosure. The conveyance path R2 corresponds to a “second conveyance path” of the present disclosure.

As depicted in FIG. 7, the conveyance path R2 branches from the conveyance path R1 at a branching point X1 in the conveyance path R1, and joins the conveyance path R1 at a joining point X2 in the conveyance path R1. The branching point X1 is located upstream of the recording part 21 in the conveyance path R1, and located downstream of the cutting position P2 in the conveyance path R1. The joining point X2 is located upstream of the branching point X1 in the conveyance path R1, and located downstream of the cutting position P2 in the conveyance path R1.

As depicted in FIG. 7, the conveying roller pair 19 is located downstream of the branching point X1 in the conveyance path RI and located upstream of the recording part 21 in the conveyance path R1. The conveyor 215 includes a conveying roller pair 26 disposed in the conveyance path R2, in addition to the sheet feed roller 17, the conveying roller pairs 19, 22, 23 and 25, and the conveying motor. The conveying roller pair 19 corresponds to a “first roller” of the present disclosure, and the conveying roller pair 26 corresponds to a “second roller” of the present disclosure.

A distance L1 along a path in which the sheet 16 is conveyed from the conveying roller pair 19 to the conveying roller pair 26 during the second conveyance, and a distance L2 along a path in which sheet 16 is conveyed from the conveying roller pair 26 to the conveying roller pair 19 during the second conveyance are both shorter than a distance L3 from the recording part 21 to the cutting position P2 in the conveyance path R1 (see FIG. 7).

In the process of step S3, the CPU 41 first causes the conveying part 215 to convey one sheet 16, among the plurality of sheets 16 accommodated in the sheet feed tray 11, in the first direction D1 so that the cutting planned position Q of the one sheet 16 is located at the cutting position P2 (step S31: first conveying process), as depicted in FIG. 8A. In the process of step S31, the first conveyance is performed.

After the process of step S31, the CPU 41 causes the cutting part 24 to cut the one sheet 16 (step S32: first cutting process), as depicted in FIG. 8B. With this, the first half part 16X and the second half part 16Y are separated from each other.

After the process of step S32, the CPU 41 causes the conveyor 215 to convey the first half part 16X and the second half part 16Y, and causes the conveyor 215 to convey the first half part 16X to the recording start position (step S33: second conveying process), as depicted in FIGS. 8C and 8D. In the process of step S33, the second conveyance is performed.

In the process of step S33, the CPU 41 first causes the conveyor 215 to convey the first half part 16X and the second half part 16Y in the first direction DI along the conveyance path R1 (see FIG. 7), as depicted in FIG. 8C, and the CPU 41 causes a rear end (an upstream end in the first direction D1) of the second half part 16Y to be located downstream of the branching point X1 in the first direction D1. In this situation, the rear end part of the second half part 16Y is held by the conveying roller pair 19. After that, the CPU 41 causes the conveyor 215 to convey the first half part 16X and the second half part 16Y in the second direction D2 (convey the first half part 16X and the second part 16Y in the opposite direction), along the conveyance path RI (see FIG. 7), as depicted in FIG. 8D. After the CPU 41 causes the first half part 161X and the second half part 161Y to return to the conveyance path R1 via the branching point X1 and through the conveyance path R2, the CPU 41 causes the conveyor 215 to convey the first half part 16X and the second half part 16Y in the first direction DI along the conveyance path R1.

Note that a sheet sensor and a flap (which are not depicted) are disposed at branching point X1. Based on a signal from the sheet sensor, the CPU 41 switches the position of the flap between a retract position at which the flap retracts from the conveyance path R1 and an enter position at which the flap enters the conveyance path R1, thereby realizing the conveyance along the conveyance paths R1 and R2 as described above.

After the process of step S33, the CPU 41 causes the recording part 21 to record the image A on the first half part 16X, as depicted in FIG. 8E (step S34: first recording process).

After the process of step S34, the CPU 41 causes the conveyor 215 to convey the second half part 16Y to the recording start position, and causes the recording part 21 to record the image B on the second half part 16Y (step S35: second recording process).

By the processes of steps S31 to S35, the first sheet piece 161 in which the image A is recorded on the first half part 16X, and the second sheet piece 162 in which the image B is recorded on the second half part 16Y are generated.

As described above, according to the present embodiment, in the second conveying process (step S33: see FIG. 8C and FIG. 8D), the CPU 41 causes the conveyor 215 to perform the second conveyance. In this case, the precision in conveyance (and further the precision in cutting and the precision in recording) can be improved. Specifically, in the second conveying process, in a case where the first half part 16X and the second half part 16Y are to be conveyed in the opposite direction (in the second direction D2) until the first half part 16X is located at the recording start position, the conveying motor needs to be rotated in the opposite direction, and thus any rattling might occur in the driving of the conveyor 215. On the other hand, in the present embodiment, the second conveyance is performed in the second conveying process, and there is no need to rotate the conveying motor in the opposite direction until the first half part 16X is located at the recording start position, and thus the rattling does not occur in the driving of the conveyor 215. As a result, the precision in conveyance (and further the precision in cutting and the precision in recording) can be improved.

The distance L1 along the path in which the sheet 16 is conveyed from the conveying roller pair 19 to the conveying roller pair 26 during the second conveyance, and the distance L2 along the path in which sheet 16 is conveyed from the conveying roller pair 26 to the conveying roller pair 19 during the second conveyance are both shorter than the distance L3 from the recording part 21 to the cutting position P2 in the conveyance path R1 (see FIG. 7). In this case, the conveying roller pair 19 and the conveying roller pair 26 can appropriately convey the cut sheet 16 (first half part 16X and second half part 16Y).

### Third Embodiment

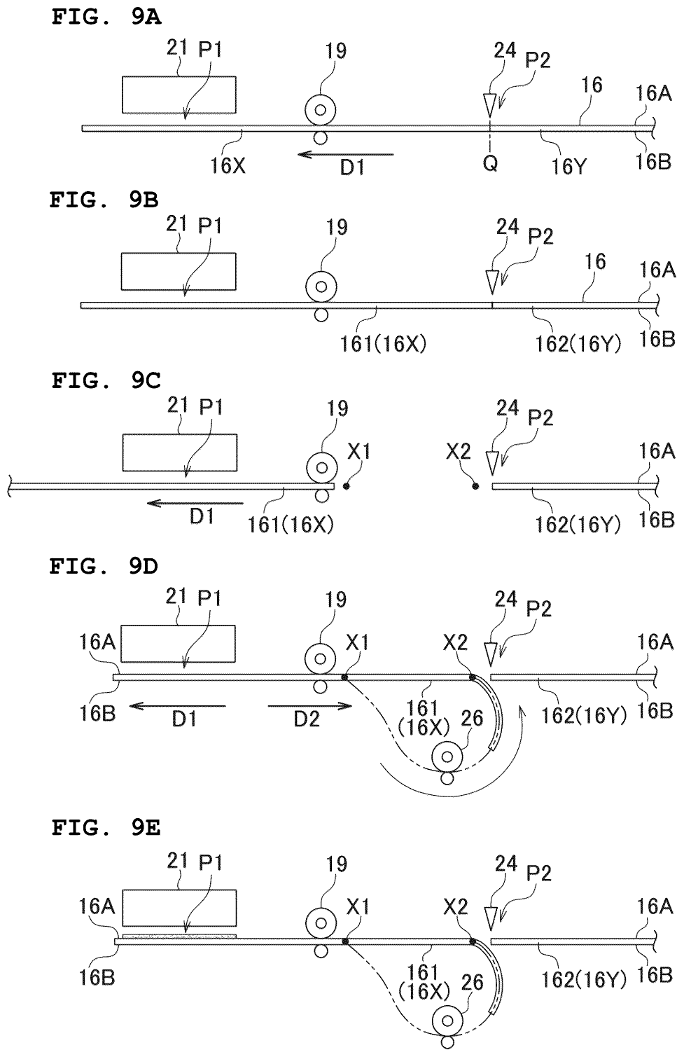

Next, a third embodiment of the present disclosure will be described with reference to FIGS. 9A to 9E.

A conveyor of the third embodiment has a configuration similar to the configuration of the conveyor 215 (see FIG. 7) of the second embodiment, and is capable of performing first conveyance and second conveyance.

In the second conveying process (step S33) of the second embodiment, the CPU 41 causes the conveyor 215 to perform the second conveyance with respect to the first half part 16X and the second half part 16Y (i.e., the CPU 41 causes the conveyor 215 to convey the second half part 16Y along the conveyance paths R1 and R2 together with the first half part 16X), thereby locating the first half part 16X at the recording start position. In contrast, in the second conveying process (step S33) of the third embodiment, the CPU 41 causes the conveyor to perform the second conveyance with respect to the first half part 16X in a state that the second half part 16Y is held at a predetermined position in the conveyance path R1, thereby locating the first half part 16X at the recording start position.

In the process of step S3, the CPU 41 first causes the conveyor to convey one sheet 16, among the plurality of sheets accommodated in the sheet feed tray 11, in the first direction D1 so that the cutting planned position Q of the one sheet 16 is located at the cutting position P2, as depicted in FIG. 9A (step S31: first conveying process).

After the process of step S31, the CPU 41 causes the cutting part 24 to cut the sheet 16 (step S32: first cutting process), as depicted in FIG. 9B. With this, the first half part 16X and the second half part 16Y are separated from each other.

After the process of step S32, the CPU 41 causes the conveyor to perform the second conveyance with respect to the first half part 16X in the state that the second half part 16Y is held at the predetermined position in the conveyance path R1, as depicted in FIGS. 9C and 9D, and causes the conveyor to convey the first half part 16X to the recording start position (step S33: second conveying process).

The “predetermined position” may be a position upstream of the recording part 21 in the first direction D1, a position upstream of the cutting position P2 in the first direction D1, or a position upstream of the joining point P2 in the first direction D1. The “predetermined position” depicted in FIG. 9C and FIG. 9D corresponds to any of the above-described three positions. Further, the term “(being) held” at the predetermined position is not limited to the sheet 16 being “stopped” at the predetermined position, and may also include the sheet 16 moving to some extent as long as the sheet 16 does not deviate from the predetermined position. For example, while the first half part 16X is being conveyed in step S33, the second half part 16Y is stopped at the predetermined position in FIG. 9C and FIG. 9D, but the second half part 16Y may be moved to some extent within the range of the predetermined position (any of the above-described positions).

After the process of step S33, the CPU 41 causes the recording part 21 to record the image A on the first half part 16X, as depicted in FIG. 9E (step S34: first recording process).

After the process of step S34, the CPU 41 executes the process (third conveying process) of causing the conveyor to convey the second half part 16Y and of causing the second half part 16Y to be located at the recording start position, then the CPU 41 causes the recording part 21 to record the image B on the second half part 16Y (step S35: second recording process).

By the processes of steps S31 to S35, the first sheet piece 161 in which the image A is recorded on the first half part 16X, and the second sheet piece 162 in which the image B is recorded on the second half part 16Y are generated.

As described above, according to the present embodiment, by conveying only the first half part 16X in step S33 (second conveying process), FPOT (First Print Out Time) can be shortened.

The joining point X2 is located downstream of the cutting position P2 in the first direction D1 (downstream of the cutting position P2 in the conveyance path R1). In this case, since the first half part 16X does not contact the second half part 16Y in step S33 (second conveying process), double feeding of the first half part 16X and the second half part 16Y can be reduced.

### Fourth Embodiment

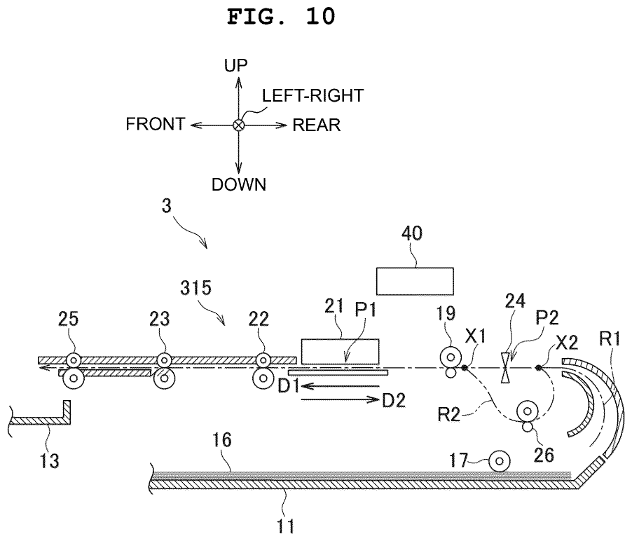

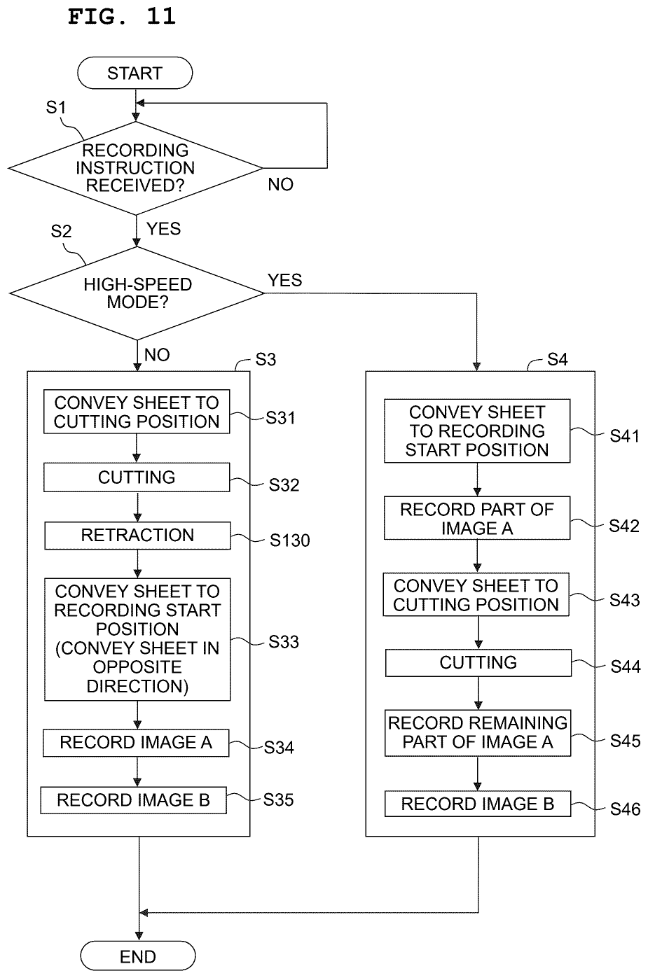

Next, a fourth embodiment of the present disclosure will be described with reference to FIGS. 10 and 11.

A printer 3 depicted in FIG. 10 is the fourth embodiment of the “recording apparatus” according to the present disclosure. The printer 3 has a configuration similar to the configuration of the printer 1 (see FIG. 2) of the first embodiment, except for the configuration of a conveyor 315.

The conveyor 315 of the fourth embodiment has a configuration similar to the configuration of the conveyor 215 of the second embodiment (see FIG. 7), except for the position of the joining point X2, and is capable of performing first conveyance and second conveyance. In the second embodiment (see FIG. 7), the joining point X2 is located downstream of the cutting position P2 in the conveyance path R1. In contrast, in the fourth embodiment (see FIG. 10), the joining point X2 is located upstream of the cutting position P2 in the conveyance path R1.

In a second conveying process (step S33) of the fourth embodiment, similarly to the second conveying process (step S33) of the third embodiment, the CPU 41 causes the conveyor 315 to perform the second conveyance with respect to the first half part 16X so as to locate the first half part 16X at the recording start position, in a state that second half part 16Y is held at a predetermined position in the conveyance path R1. Further, in the fourth embodiment, the process of step S3 (first control) includes a process of step S130 (retracting process: fourth conveying process) after the process of step S32 (first cutting process) and before the process of step S33 (second conveying process), as depicted in FIG. 11.

In the process of step S130, the CPU 41 causes the conveyor 315 to convey the second half part 16Y to the predetermined position. For example, the CPU 41 causes the conveyor 315 to convey the second half part 16Y in the second direction D2 and causes the second half part 16Y to be located at the predetermined position which is a position upstream of the joining point X2 in the first direction D1.

As described above, according to the present embodiment, the process of step S130 (retracting process: fourth conveying process) is executed after the process of step S32 (first cutting process) and before the process of step S33 (second conveying process). As a result, the first half part 16X does not contact the second half part 16Y in the process of step S33 (second conveying process), and therefore the double feeding of the first half part 16X and the second half part 16Y can be reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the foregoing, although the embodiments of the present disclosure have been described, the present disclosure is not limited to the above-described embodiments, and various design changes are possible within the scope of the claims.

For example, the medium is not limited to the sheet, and may be cloth, a resin member, etc.

The recording part is not limited to the recording part of the ink-jet system, and may also be a recording part of the laser system, the thermal transfer system, etc.

The present disclosure is not limited being applicable to the printer, and may be applicable also to a facsimile, a copying machine, a multi-function peripheral, etc.

The program according to the present disclosure can be distributed while being stored on a removable storage medium such as a flexible disk, etc., a fixed storage medium such as a hard disk, etc. Further, the program according to the present disclosure can be distributed via a communication line.

What is claimed is:

1. A recording apparatus comprising:
an accommodating part configured to accommodate a medium;
a recording part configured to record an image on the medium;
a conveyor configured to convey the medium from the accommodating part toward the recording part along a first conveyance path;
a cutting part configured to cut the medium at a cutting position and divide the medium into a first medium and a second medium; and
a controller, wherein
the cutting position is located upstream of the recording part in the first conveyance path,
the controller is configured to execute first control to generate a first recorded item in which a first image is recorded on the first medium and a second recorded item in which a second image is recorded on the second medium, and
the first control includes:
causing the conveyor to convey one medium accommodated in the accommodating part so that a cutting planned position of the one medium is located at the cutting position;
causing the cutting part to cut the conveyed one medium and divide the one medium into the first medium and the second medium;
causing the conveyor to convey the first medium from downstream toward upstream of the first conveyance path so as to locate the first medium at a recording start position;
causing the recording part to record the first image on the first medium; and
after causing the recording part to record the first image on the first medium, causing the recording part to record the second image on the second medium.

2. The recording apparatus according to claim 1, wherein
the controller determines whether a first mode or a second mode having a recording speed lower than a recording speed of the first mode is selected,
in a case where the controller determines that the first mode has been selected, the controller is configured to execute second control, which is different from the first control, so as to generate the first recorded item and the second recorded item, and
the second control includes:
causing the conveyor to convey one medium accommodated in the accommodating part to the recording start position;
causing the recording part to record at least a part of the first image on the one medium;
after causing the recording part to record at least the part of the first image on the one medium, causing the conveyor to convey the one medium so that the cutting planned position the one medium is located at the cutting position;
after causing the conveyor to convey the one medium so that the cutting planned position of the one medium is located at the cutting position, causing the cutting part to cut the one medium; and
after causing the cutting part to cut the one medium, causing the recording part to record the second image on the second medium.

3. The recording apparatus according to claim 1, wherein
the medium has a first surface and a second surface opposite the first surface,
the conveyor is configured to perform first conveyance of conveying the medium along the first conveyance path so that the first surface faces the recording part, and second conveyance of performing conveyance of the medium so that a state that the first surface faces the recording part is changed to a state that the second surface faces the recording part, by conveying the medium from the first conveyance path and conveying the medium to return to the first conveyance path via a second conveyance path branching from the first conveyance path at a branching point in the first conveyance path and joining the first conveyance path at a joining point in the first conveyance path which is located upstream of the branching point in the first conveyance path,
in a case where the controller causes the conveyor to convey the one medium accommodated in the accommodating part so that the cutting planned position of the one medium is located at the cutting position, the controller causes the conveyor to perform the first conveyance, and
in a case where the controller causes the conveyor to convey the first medium from downstream toward upstream of the first conveyance path so as to locate the first medium at the recording start position, the controller causes the conveyor to perform the second conveyance.

4. The recording apparatus according to claim 3, wherein
the conveyor includes:
a first roller disposed downstream of the branching point in the first conveyance path; and
a second roller disposed in the second conveyance path, and
a distance along a path in which the medium is conveyed from the first roller to the second roller during the second conveyance, and a distance along a path in which the medium is conveyed from the second roller to the first roller during the second conveyance are both shorter than a distance from the recording part to the cutting position in the first conveyance path.

5. The recording apparatus according to claim 3, wherein
in a case where the controller causes the cutting part to cut the conveyed one medium, the first medium is located downstream of the second medium in the first conveyance path,
in a case where the controller causes the conveyor to convey the first medium from downstream toward upstream of the first conveyance path so as to locate the first medium at the recording start position, the controller causes the conveyor to perform the second conveyance with respect to the first medium in a state that the second medium is held at a predetermined position in the first conveyance path, thereby locating the first medium at the recording start position, and
the first control further includes causing the conveyor to convey the second medium so as to locate the second medium at the recording start position, after causing the recording part to record the first image on the first medium and before causing the recording part to record the second image on the second medium.

6. The recording apparatus according to claim 5, wherein
the joining point is located downstream of the cutting position in the first conveyance path.

7. The recording apparatus according to claim 5, wherein
the joining point is located upstream of the cutting position in the first conveyance path, and
the first control further includes causing the conveyor to convey the second medium to the predetermined position, after causing the cutting part to cut the conveyed one medium and before causing the conveyor to convey the first medium from upstream toward downstream of the first conveyance path so as to locate the first medium at the recording start position.

8. The recording apparatus according to claim 1, wherein
in a case where the controller causes the conveyor to convey the first medium from downstream to upstream of the first conveyance path so as to locate the first medium at the recording start position, the controller causes the conveyor to convey the second medium together with the first medium.

9. The recording apparatus according to claim 1, wherein
the accommodating part is configured to accommodate a plurality of media including the medium, a length along the first conveyance path being different amount the plurality of media, and
a distance from the recording part to the cutting position in the first conveyance path is smaller than half the length of a recording medium having the length which is greatest among the plurality of recording media.

10. The recording apparatus according to claim 1, wherein
a distance from the recording part to the cutting position in the first conveyance path is 182 mm or less.

11. A control method of controlling a recording apparatus,
the recording apparatus including:
an accommodating part configured to accommodate a medium;
a recording part configured to record an image on the medium, a conveyor configured to convey the medium from the accommodating part toward the recording part along a first conveyance path;
a cutting part configured to cut the medium at a cutting position and divide the medium into a first medium and a second medium; and
the cutting position being located upstream of the recording part in the first conveyance path,
the control method comprising:
executing first control to generate a first recorded item in which a first image is recorded on the first medium and a second recorded item in which a second image is recorded on the second medium,
the first control including:
causing the conveyor to convey one medium accommodated in the accommodating part so that a cutting planned position of the one medium is located at the cutting position;
causing the cutting part to cut the conveyed one medium and divide the one medium into the first medium and the second medium;
causing the conveyor to convey the first medium from downstream toward upstream of the first conveyance path so as to locate the first medium at a recording start position;
causing the recording part to record the first image on the first medium; and
after causing the recording part to record the first image on the first medium, causing the recording part to record the second image on the second medium.

12. A non-transitory computer-readable medium storing a control program for controlling a recording apparatus,
the recording apparatus including:
an accommodating part configured to accommodate a medium;
a recording part configured to record an image on the medium;
a conveyor configured to convey the medium from the accommodating part toward the recording part along a first conveyance path;
a cutting part configured to cut the medium at a cutting position and divide the medium into a first medium and a second medium; the cutting position being located upstream of the recording part in the first conveyance path; and
a controller,
the program causing the controller of the recording apparatus to execute:
first control to generate a first recorded item in which a first image is recorded on the first medium and a second recorded item in which a second image is recorded on the second medium;
in the first control, the program causing the controller to execute:
causing the conveyor to convey one medium accommodated in the accommodating part so that a cutting planned position of the one medium is located at the cutting position;
causing the cutting part to cut the conveyed one medium and divide the one medium into the first medium and the second medium;
causing the conveyor to convey the first medium from downstream toward upstream of the first conveyance path so as to locate the first medium at a recording start position;
causing the recording part to record the first image on the first medium; and
after causing the recording part to record the first image on the first medium, causing the recording part to record the second image on the second medium.
